(19) United States
(12) Patent Application Publication
(10) Pub. No.: US 2008/0065399 A1
(43) Pub. Date: Mar. 13, 2008

(54) Formula for building a corporation

(76) Inventor: Laurie A. Levin, Santa Monica, CA (US)

Correspondence Address: FULBRIGHT & JAWORSKI;MARKET SQUARE, 801 PENNSLYVANIA, N.W., WASHINGTON, DC, 200042604, US

(21) Appl. No.: 11/519,771

(22) Filed: Sep. 13, 2006

(51) Int. Cl. G06Q 10/00; G06Q 30/00

(52) U.S. Cl. 705/1

(57) ABSTRACT

The invention relates to a process for establishing and implementing an endeavor. The endeavor may be the organization and operation of a company, a commercial project or other project. The process involves establishing one or more objectives of the endeavor, establishing roles for participants in the endeavor, establishing a collective approach to achieving the objectives of the endeavor, and collectively establishing a plan of steps intended to achieve the objectives. The process also involves performing according to the plan of steps and re-evaluating the plan recursively. The process implements the concepts of soul communion in order to enhance effective action through inspiration facilitated by soul communion.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A COMPACT DISK APPENDIX

Not applicable.

### TECHNICAL FIELD

The invention relates to a process for enhancing effective action and more particularly a process for effectively building a structure to achieve a corporate objective.

### BACKGROUND OF THE INVENTION

It is known that human potential and the potential for perception are far greater than that normally experienced. See, for example, Kenneth Ring, Ph.D., Lessons From the Light (Moment Point Press 1998) and Kenneth Ring, Ph.D., Heading Toward Omega (William Morrow & Co. 1985). In these references, the author expounds on Near Death Experiences (NDE's) and commonality revealed through an experience he calls Life Review. In life review, people have reportedly re-experienced a piece of the person's life not only through their own perspective, but also have perceived the same past experience simultaneously through the perspective of others. This provides an understanding of an event or series of events from the perspective of themselves and others, termed “mutuality.” This mutuality provides the person an integration of intuitive information in understanding the soul at work in each moment.

### BRIEF SUMMARY OF THE INVENTION

It is an object of the invention to provide a process for enhancing effective analysis and planning toward achieving an objective.

The process is rooted in adjusting our own mental preconceptions and attaining openness to inspiration while minimizing pre-conceived limitations to our decision-making process.

The new construct is rooted in a belief that humanity is part of a collective, but the collective is not simply what exists with the tangible, the seen, and/or what is perceived through all five senses. One foundational aspect of this model is mutuality.

According to an aspect of the invention, the first communications and requests toward the shared mission may be on the subtle plane. Communication, agreements and commitments that transpire may be first made on the subtle plane and then brought into the dense physical plane to be carried out for mutual growth. An aspect of the invention may rely on trust that all exchanges are mutual and that all exchanges enrich the growth of the endeavor.

According to the invention, an aspect of the process may rely on a trust that all members' higher selves will guide the timing. When the endeavor maintains a willingness to keep growing and exploring their subtle and dense physical expressions with courage and awareness, the exchange can expand to create a collective energetic dynamic that is greater than the sum of its individual parts. That there is trust that each experience aims BOTH toward soul development as well as toward the shared mission, they are indeed mutual.

According to the invention, there may be a focus on soul, as it includes the level of unconscious at work. The concept of soul refers to each one's sense of his/her higher self as an emissary to his or her own unconscious as well as to a perception of a collective connection to their higher-self world.

Goals of the process according to the invention include one or more of:

making the unconscious conscious;

To see all expression as having a purpose;

Cultivating a company who accesses, identifies and integrates intuitive information;

focus on the soul as it includes the level of the unconscious at work on the company's behalf;

group prayer to constantly review and refine the company mission.

The objects can be achieved through a process according to the invention based, at least in part, through soul communion. Under soul communion, an individual's soul can be viewed as an agent for self-growth, self-protection and action with an abiding principle that all information is valid. An individual's thoughts and experiences are not to be seen as random or without meaning. When soul communion is applied in a group, mutuality brings the soul group growth as an agent for shared directives and group think. Group experiences should not be seen as random or without meaning. Each individual's addition to the whole is in one way unique to their personal expression and, at the same time, is in collusion with the greater established group goal or goals.

An aspect of soul communion involves “Making the Unconscious Conscious.” For example, when a person cannot shake a lyric or refrain from his or her thoughts it is a metaphor with deeper significance for self-understanding; a twitch in a person's eye may be a signal of sadness or repressed tears; and an awakening in the middle of the night may hold the key to resolving issues the person has been considering during the day. A person's “soul” helps them understand all the information encountered in daily life. It does that in many ways, but on an “as needed basis.” So, too, when mutuality brings Soul Communion, the group's souls help the group understand all the information it needs on an “as needed basis.” Consciousness is characterized by that which is measurable, understandably distinct or readily apparent. By contrast the unconscious is not normally accessible by reason or words. Actually, people can relate to both the conscious and unconscious from two different perspectives: the physical realm by which people perceive through our five senses and the intuitive realm by which people perceive through alternative forms of spiritual energy. Soul Communion is characterized by making the unconscious conscious.

The intuitive realm is made up of a person's “higher” or “God-self,” and includes other souls who have passed to the other or non-physical dimension. Such “souls” do not interfere with a person's life unless the person raises receptiveness through meditation, visualization, prayer or other mechanism to be open to inspiration. Such souls have purpose and themes to their expression just as people do in the dense physical dimension. When entertaining new corporate directives, a person may call on those from the other side who want to assist. They have both the know-how as well as the desire to work as a group. They, too, grow together and with us, just as we grow together and with them.

The struggle for company results is not found when one side conquers or dominates the other. Soul Communion holds that if we were able to find acceptance for all aspects, truly entertain the merit of every thought or intuition, as well as provide invitation for your partners from the unseen “subtle realm” to add to that exchange, then what will unfold is far greater than what any one of us could or would ever do alone. And that “greater” is trusted to be exactly what is needed.

Identifying Intuitive Information. A person's intuitive abilities tend to get pushed into the distant background of the person's life because at an early age we are trained to react to daily life rather than slowing down to see the meaning of our lives. Intuition can be accessed through meditation, active visualization, remembering dreams or listening to the signals of one's body. All intuition has value, even if it suggests that you do something that is seemingly off point, because it prompts a personal or group inventory of deeper questioning that may help solve a fundamental issue not previously addressed. Integrating a person's intuition takes place when the person's body, mind, emotion and spirit all come together for the person and with others in exchanges that enrich our experience and growth. Soul Communion teaches a person to become more keenly aware of communication that takes place indirectly or subconsciously by connecting to others. One can feel into another or enter into another soul to better intuit or understand. Much the way one would visualize entering into a car, you visualize entering or inquiring into another. The inquirer holds himself still and quiet, much the way you would do in a “normal” conversation after you posed a question. In the stillness, wait for signals that can come in many forms: thoughts, body knowing, dreams, etc. Soul Communion's teachings are based on empirical and remarkably consistent reports of those that have near-death (NDE) experiences resulting in a belief in life after life as they have encounters with nonphysical souls. The corporate Soul Communion will more solidly trust in the connectedness to themselves and to their shared guidance realm. The corporate Soul Communion invites the combined souls present on the physical and nonphysical realm to sign on to the mission. All inquiring toward building under that mission is understood to be invested with the “larger” team's input. Group meetings may allow for a meditative or still moment to give invitation for all's input. Trust that what each member reports has stark understanding of view, after everyone shares their view, then the group can move into collaboration. Soul Communion assumes that the physical and nonphysical members are all represented.

Soul Communion toward corporate directives initiates a chain of community shifts. Each participant is forced to break down his or her natural tendencies to be a loner. It helps to first establish each one's unique contribution, so that one doesn't feel so absorbed by the group. They feel honored for their own unique expression and enjoy adding that to the shared mission of all.

Another foundational cornerstone of this new model of doing business—the feminine and masculine principles of receiving and giving are in balance. By setting up a corporate culture of inquiry (on all realms) and trusting in receiving (on all realms): THE FEMININE; as well as an understanding that all the doing (on all realms) and acquiring (on all realms): THE MASCULINE team establishes an assurance of coalescence and balance.

CO-CREATION and COLLABORATION on a UNIVERSAL LEVEL—At the time the entire team is setting up the mission, attention is paramount in setting up the “measures of success” and “the corporate goals.” Traditional corporate goals of currency and profit may not be the only measure of success. Set up a systematic inventory as to what the desires, goals and vision are. Use group prayer to insure that the whole team, including all realms, is on board for the mission and all of its intricacy. Co-creation: Much attention is to be paid to the initial construction, not that it cannot be a living, evolving mission, but because of that creation, each of the team members will go through shifts and growth both individually and as a collective by signing on to the tasks at hand. The more that each team member is truly committed and in alignment with the process, the more completion and ease, the more momentum and impact.

Aspects of the invention may be enhanced through application of one or more of the following constraints.

1. NO EDIT RULE. The members of the team aspire to bring forth all information, since everything that they are undergoing affects the group at large. A purpose of mutual expression and respect will attain a dimension of no unspoken feelings, thereby creating connection.

2. It is assumed that THE SUBTLE “SPEAKS” THROUGH EVERYONE—that they, too, bring forth all their information through all the various methods of communicating.

3. Each member is LISTENED to with reverence and respect. See the perfection in everyone's expression. Often the simple act of listening to another gives the receiver fear. It can ignite fears of being swallowed up, suffocated or taken over, which is an illusion, because nobody else can take us over or force us to respond. It also forces us to examine our own experience, because it is impossible for a person to empathize with another if the person is hiding something from himself or herself. Actually listening to another, taking in their imagery, attuning to what they're feeling without fear that somehow through that act we'd lose ourselves or our position, allows for group security and solidity. When we attune with someone else, we never lose ourselves.

4. In aspiration to bring all information forth, the corporation also faces the places that are blocked or repressed. Question if there are “dead zones,” stare them square in the eye and commit to further understand. (One has to face their death, in order to know their life. If one has a fear of confrontation, then it is created all the time, because just in the state of avoidance, in order to push it down, in being braced for it, looking for it to avoid, it ends up controlling you and you are actually in the state of confrontation all the time. We tend to see one side at a time; that's the polarity, that's the relativity we live through.) Once all information is brought forward, fears can be cleared, the corporation is empowered to state its mission, its objectives, and steer TOWARD SEEING THE WHOLE PICTURE.

5. Striving to make every moment count. (We rush to do the housework so we can hurry up and get to the real business at hand, but the real business at hand is doing the housework . . . not just to get the table clean, but to love it, feel it and get into it.) EVERY MOMENT IS FULL AND ALIVE. No effort is judged as too small.

6. Corporate mission is to give up usual and customary protestant work ethic around competition, suffering, anguish, and struggle. (If there is no struggle, then members do not feel alive. Not to invest in usual tug-o-war with a big rope and some imaginary foe. Just drop the rope.) SEE THE COMPANY THRIVING AND ALIVE IN HARMONY, no more need for duality.

7. CORPORATE DEDICATION TO BREAKING USUAL AND CUSTOMARY STIMULUS/RESPONSE. Corporate awareness that with Soul Communion no need to respond to stimulus, but observe all repetitive imagery, in an effort to break response, and look at the situation with the idea to understand it from new vantages. EXPAND understanding and corporate EXPRESSION. Past beliefs that are wounds are stored in memory mechanisms of old corporate consciousness. They can play out in the present, even though the moment may have nothing to do with the original wound. Each member's willingness to unlock old knee-jerk responses and allow the corporation to see what serves it best today opens expression through a more integrated knowing.

8. LIVE IN PERFECT TRUST that all is in profound design of divine perfection. See the connectedness of all, on all levels, and feel the rich expression of “isness” itself.

9. DEMAND IT ALL. Complete support to the corporate process-people, money, access—so that the journey is bountiful.

10. DEMAND IT ALL. Bring together a group that is able to defy the morass of corporate politics to enjoy respect, growth, sharing and building dreams together.

11. DEMAND IT ALL. End duality. Let everyone give as well as receive. Let everyone be able to voice as well as listen. Set forth a new kind of balance within all.

12. That these demands be blessed with an open readiness to corporate EVOLUTION.

13. To expand on patterns of the past, invite the corporate entity (from ALL realms) to help with the evolution. Disjunction and discord exist when there are blocks on expression. INVITE THE CORPORATE ENTITY TO EXPAND EXPRESSION. Nothing will be annihilated. Nothing will be lost. You cannot “unknow” what you already know. Trust that all transformations will enhance the company.

14. SOUL COMMUNION asks you to look to your everyday events and affairs as being emblematic to your inner quest as well as your outer journey. The outer world is often the teacher to the inner world. The readiness for evolution comes from a corporate attitude that is often met by a parallel outer event. Events and opportunities are not seen as challenges, but rather interconnected to the corporate whole. No event is more fundamental than another. ALL AFFAIRS ARE INSTRUMENTS FOR POSITIVE GROWTH. DEVELOP AWARENESS OF THE OUTER WORLD BEING A REFLECTION OF THE INNER WORLD. As the corporate readiness and commitment to change and evolution become conscious, an external reflection of the growth begins to express.

15. SOUL COMMUNION adheres to the belief that there is exquisite timing and confluence to outer reality conspiring to bring the corporation just what is needed to learn and grow.

16. The corporate relationships, in order to reflect the shifts and expansion, may require a reintegration time. Trust the timing and that life will bring the corporation and those involved with it exactly what is needed.

17. SOUL COMMUNION asks the corporation TO ACKNOWLEDGE AND HONOR YOUR ACCOMPLISHMENTS AT EACH JUNCTURE. Each review can be enhanced through nourishing acts of corporate appreciation.

### BRIEF DESCRIPTION OF THE DRAWINGS

FIG. 1 shows a flow diagram for an embodiment of the process according to the invention.

FIG. 2 shows a flow diagram for a sub process for use according to an embodiment of the process according to the invention.

### DETAILED DESCRIPTION OF THE INVENTION

The process may be broken down to the following steps:

Assemble participants for endeavor

Prepare participants to be receptive to co-creating endeavor

Call on souls past and present for guidance

Group prayer

Group think tank

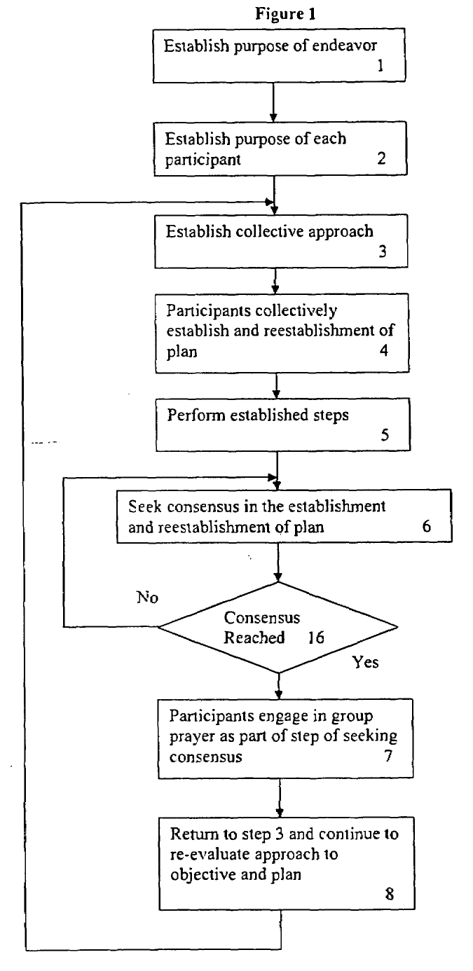

As illustrated in FIG. 1, the first step of the process, 1, according to an embodiment of the invention, is for the participants to establish the purpose of the endeavor. The endeavor may advantageously be the establishment of a commercial endeavor such as a corporation. One example might be the establishment and implementation of a business plan. The method according to the invention may be equally applicable to a special project such as the design and development of a new product or service, implementation of sales, marketing or distribution strategy or any other endeavor. Multiple individuals will participate in the establishment and achieving the goals of the endeavor. The next step, 2, is to establish a purpose and plan for each of the participants. Understanding the purpose of the endeavor as a whole and of each participant may facilitate a collective expression which will transform into creation of a direction for the endeavor.

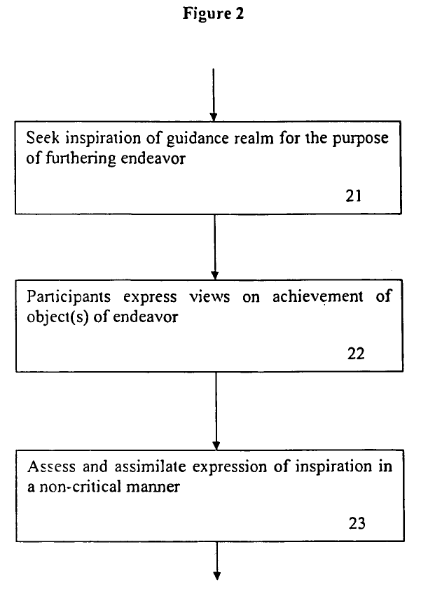

The next step, 3, is to establish a collective approach for the endeavor. As illustrated in FIG. 2, the establishment of the collective approach may be accomplished through seeking inspiration of the guidance realm for the purpose of furthering the endeavor, 21. This may be accomplished by asking the guidance realm to bring to the endeavor and each participant the capacity for expression of views towards a desired result with freedom from fear of recrimination, shame, blame, judgment, and without seeking credit. The participants may express views on achievement of the objectives of the endeavor, 22, and the participants may collectively assess and assimilate expression of inspiration in a non-critical manner, 23. The collective, including the dense and guidance realm, is responsible for the inspiration.

Following establishment of the collective approach, the participants may collectively establish a plan intended to lead towards achieving the objectives of the endeavor, 4. In establishing the plan, each soul's uniqueness is valued and addressed. Preferably, no participant's expression is stifled, edited or sacrificed at the expense of expression of another participant. Performance of the steps established according to the plan is initiated and carried forward, 5. Simply performing the steps according to the established plan should be accomplished by or at the direction of the participants while giving trust to the process in accordance with the above precepts. Advantageously, the participants should enjoy and respect the process with a sense for the adventure attendant to the journey towards achieving the objectives of the endeavor.

An aspect of the process according to a preferred embodiment of the invention requires the participants to seek consensus in the establishment and re-establishment or refinement of the plan, 6. During the process, at 7, participants engage in group prayer as part of the step of seeking consensus.

The process requires a recursive renewal of the plan for achieving the corporate objectives. The participants should renew their dedication to the collective approach addressed in step 3 above and continue through some or all of process steps 3 through 7 as they work towards achieving the corporate objectives.

The afore-described approach allows for perceptions to shift, rigidity of participants to break down, and for the participants to become open to new ways of approaching the objectives of the endeavor. This process is designed for the participants to forgo an individualistic approach in favor of a team approach. Some objectives may take longer than by a conventional approach and some may take less time. The process involving both dense physical souls and subtle realm souls requires collaboration and consensus. The establishment of consensus is intended to facilitate greater stability and ground breaking outcomes.

According to an additional feature, 16, of the invention, consensus shall be required prior to proceeding. In order to achieve consensus, the participants shall participate in group prayer in conjunction with the subtle realm in order to establish inner group solidarity before proceeding with further action. The collective shall fully embrace a higher purpose and reject ego-based energy. It is important for the collective to honor a higher dream realm as a preparation, transformation, or consultation ground towards the objective of the endeavor.

Soul communion is based on a belief that the participants can co-create a collective community. Such a collective community is intended to have enhanced effectiveness and power towards achieving the objectives of the endeavor. The process according to the invention facilitates the initiation and inspiration of the participants to facilitate achievement of greater objectives.

The process includes opening oneself up to the possibility of seeking guidance or inspiration from a plane beyond our consciousness.

According to the invention, a new process or novel method is provided for building a corporate team connected to all souls, past, present and future, which represent the “guidance realm” that will inform and assist in the construction of the full range of requirements for an endeavor.

1. Soul Communion permits a team to come together to form a collective in order to achieve the objectives of an endeavor based on a common belief, that by forming a partnership with “the guidance realm” the participants are open to all possibilities so that their mission will manifest with completion and ease.

2. By forming a partnership in Soul Communion, it is understood that the souls, past, present and future, most appropriate for the endeavor at hand will come together.

3. Soul Communion relies on a communion coming in the form of shared group knowing or individual experiences of thoughts, intuition, lucid day dreams, night dreams, Para-normal activity, or seeing extra meaning from everyday occurrences that hold a certain synchronistic truth.

4. Soul Communion requires decisions made through consensus with no political hierarchy.

5. The bonding of Soul Communion comes on an as-needed basis through group prayer to exchange energy, to give thanks for results, and to shed light on situations requiring resolution.

According to the invention, the analytic process is about making the unconscious conscious. It is the foundational cornerstone to all analytic process. The psychological concept of consciousness has to do with what is measurable and/or distinct, and/or explicable. The unconscious is where it is not accessible by reason or words.

In Soul Communion there are two realms of conscious and unconscious co-existing on a parallel continuum. The subtle and the dense physical realms are both methods of expression.

Soul Communion accepts all expression. The dark and difficult expression is just as acceptable as a constant inquiry for the light or an expression of knowledge and enlightenment. All is in balance. All is valid. There is no judgment. All parts are acceptable because of the shared mission.

The perpetual intention toward the mission brings about completion and ease.

While the preferred embodiment(s) have been described in detail, various alternatives for practicing the invention are within the scope of the invention which is defined by the following claims.

What is claimed is:

1. A process comprising the steps of:
establishing one or more objectives of an endeavor;
establishing roles for participants in the endeavor;
establishing a collective approach to achieve said one or more objectives of the endeavor;
two or more participants in the endeavor collectively establishing a plan of steps intended to lead toward achieving said one or more objectives;
performing said steps intended to lead toward achieving said one or more objectives; and
re-evaluating said plan of steps intended to lead toward achieving said one or more objectives.

2. A process according to claim 1 further comprising the step of seeking consensus in said plan of steps.

3. A process according to claim 2 wherein the step of seeking consensus further comprises the participants engaging in group prayer.

4. A process according to claim 2 further comprising the step of requiring consensus prior to proceeding.

5. A process according to claim 1 wherein said step of re-evaluating further includes recursively performing the steps of re-establishing a collective approach to achieve said one or more objectives of the endeavor and re-establishing a plan of steps intended to lead toward achieving said one or more objectives.

6. A process according to claim 1 wherein the step of establishing a collective approach further comprises the steps of
seeking inspiration;
one or more participants expressing views on achievement of said one or more objectives of said endeavor; and
collectively assessing and assimilating said views.

7. A process according to claim 6 wherein said step of assessing and assimilating is performed in a non-critical manner.

8. A process according to claim 6 wherein said step of seeking inspiration further comprises seeking inspiration from a guidance realm.

9. A process according to claim 6 wherein said step of seeking inspiration further comprises seeking a capacity for expression of views with freedom from fear.

10. A process according to claim 9 wherein said step of seeking inspiration further comprises seeking a capacity for expression of view without seeking credit.

11. A process according to claim 1 wherein the step of establishing said plan of steps is performed wherein uniqueness of each participant is valued and addressed.

12. A process according to claim 1 wherein the step of establishing said plan of steps is performed without stifling the expression of any participant.

13. A process according to claim 12 wherein the step of performing said plan of steps is performed without editing or sacrificing expression of a participant at the expense of the expression of another participant.

14. A process of instructing one or more individuals on establishing an endeavor comprising the steps of:
instructing said one or more individuals to establish one or more objectives of an endeavor;
instructing said one or more individuals to establish roles for participants in the endeavor;
instructing said one or more individuals to establish a collective approach among said participants to achieve said one or more objectives of the endeavor;
instructing said one or more individuals to have two or more participants in the endeavor collectively establish a plan of steps intended to lead toward achieving said one or more objectives;
instructing said one or more individuals that said participants shall then perform said steps intended to lead toward achieving said one or more objectives; and
instructing said one or more individuals to have said participants re-evaluate said plan of steps intended to lead toward achieving said one or more objectives.

15. A process according to claim 14 further comprising the step of instructing said one or more individuals to seek consensus in said plan of steps among participants in said endeavor.

16. A process according to claim 15 further comprising the step of instructing said one or more individuals to require consensus in said plan of steps among participants in said endeavor prior to proceeding.

17. A process according to claim 15 wherein the step of instructing said one or more individuals to seek consensus among said participants in said endeavor further comprises the step of instructing said one or more individuals to have said participants engage in group prayer.

18. A process according to claim 14 wherein said step of instructing said one or more individuals to re-evaluate further includes the step of instructing said one or more individuals to have said participants recursively repeat the steps of re-establishing a collective approach to achieve said one or more objectives of the endeavor and re-establishing a plan of steps intended to lead toward achieving said one or more objectives.

19. A process according to claim 14 wherein the step of instructing said one or more individuals to establish a collective approach further comprises the steps of
instructing said one or more individuals that participants should seek inspiration;
instructing said one or more individuals that one or more participants should express views on achievement of said one or more objectives of said endeavor; and
instructing said one or more individuals that said participants should collectively assess and assimilate said views.

20. A process according to claim 19 wherein said step of instructing said one or more individuals that said participants should collectively assess and assimilate further comprises the step of instructing said one or more individuals that said participants should assess and assimilate in a non-critical manner.

21. A process according to claim 19 wherein said step of instructing said one or more individuals that said participants should seek inspiration further comprises the step of instructing said one or more individuals that said participants should seek inspiration from a guidance realm.

22. A process according to claim 19 wherein said step of instructing said one or more individuals that said participants should seek inspiration further comprises the step of instructing said one or more individuals that said participants should seek a capacity for expression of views with freedom from fear.

23. A process according to claim 22 wherein said step of instructing said one or more individuals that said participants should seek inspiration further comprises the step of instructing said one or more individuals that said participants should seek a capacity for expression of view without seeking credit.

24. A process according to claim 14 wherein the step of instructing said one or more individuals that said participants should establish said plan of steps further comprises instructing said one or more individuals that establishing said plan of steps is performed wherein uniqueness of each participant is valued and addressed.

25. A process according to claim 14 further comprising the step of instructing said one or more individuals that the step of two or more participants in the endeavor collectively establish a plan of steps establishing is performed without stifling the expression of any participant.

26. A process according to claim 25 wherein the step of instructing said one or more individuals that performing said plan of steps is to be performed without editing or sacrificing expression of a participant at the expense of the expression of another participant.
